(19) United States
(12) Patent Application Publication
(10) Pub. No.: US 2017/0187428 A1
(43) Pub. Date: Jun. 29, 2017

(54) CoMP JT COMMUNICATION METHOD AND BASE STATION

(71) Applicant: Huawei Technologies Co., Ltd., Shenzhen (CN)

(72) Inventors: Lu GUAN, Chengdu (CN); Xiongshu Yi, Chengdu (CN)

(73) Assignee: Huawei Technologies Co., Ltd., Shenzhen (CN)

(21) Appl. No.: 15/455,238

(22) Filed: Mar. 10, 2017

Related U.S. Application Data
(63) Continuation of application No. PCT/CN2015/089401, filed on Sep. 11, 2015.

(30) Foreign Application Priority Data
Sep. 12, 2014 (CN) 201410466513.1

(51) Int. Cl. H04B 7/024; H04L 5/00; H04W 4/06; H04W 72/04

(52) U.S. Cl. CPC H04B 7/024; H04W 72/042; H04L 5/0048; H04W 72/0446; H04W 4/06; H04W 72/0426

(57) ABSTRACT

Embodiments of the present application disclose a CoMP JT communication method, used to implement CoMP JT communication in communication of LTE R9 and an earlier release. The method in the embodiments of the present application includes: configuring, by a serving base station, a JT serving subframe; sending, by the serving base station, coordination information to a coordinated base station, so that the coordinated base station configures a JT coordinated subframe according to the coordination information; and when UE in a serving cell needs to perform CoMP JT communication, sending, by the serving base station, the JT serving subframe to the UE in the serving cell to provide a CoMP JT communication service for the UE in the serving cell. The embodiments of the present application further provide a related base station.

### CROSS-REFERENCE TO RELATED APPLICATIONS

This application is a continuation of International Application No. PCT/CN2015/089401, filed on Sep. 11, 2015, which claims priority to Chinese Patent Application No. 201410466513.1, filed on Sep. 12, 2014, The disclosures of the aforementioned applications are hereby incorporated by reference in their entireties.

### TECHNICAL FIELD

The present application relates to the field of communications, and in particular, to a CoMP JT communication method and a base station.

### BACKGROUND

With development of communications technologies, a coordinated multipoint (CoMP) transmission technology is also becoming increasingly mature. The CoMP technology mainly refers to the following: Base stations of multiple cells that include a serving cell and a coordinated cell perform data reception or transmission in a coordinated manner, to improve received signal quality of user equipment (UE)/an evolved NodeB (eNodeB), reduce inter-cell interference, and increase a cell-edge user throughput and a cell average throughput.

Specifically, the CoMP technology includes joint transmission (JT). CoMP JT communication is applicable to a cell-edge user, and can improve received signal quality of UE in a serving cell, or eliminate interference to another UE. In Long Term Evolution (LTE) R10 and a later release, a base station uses a multimedia broadcast multicast service single frequency network (MBSFN) subframe to transmit JT data, and UE transparently receives the JT data, thereby implementing CoMP JT communication.

However, UE of LTE R9 and an earlier release cannot use an MBSFN subframe to perform beamforming transmission, and further cannot transparently receive JT data transmitted on the MBSFN subframe. Therefore, in the prior art, the UE of LTE R9 and an earlier release cannot perform CoMP JT communication.

### SUMMARY

Embodiments of the present application provide a CoMP JT communication method, used to implement CoMP JT communication in communication of LTE R9 and an earlier release.

A first aspect of the embodiments of the present application provides a coordinated multipoint CoMP joint transmission JT communication method, including:

receiving, by a coordinated base station, coordination information from a serving base station;

configuring, by the coordinated base station, a JT coordinated subframe according to the coordination information, where the JT coordinated subframe is a normal type subframe, the JT coordinated subframe is used to: when user equipment UE in a serving cell needs to perform CoMP JT communication, send JT data of the UE in the serving cell together with a JT serving subframe configured by the serving base station, the serving base station is configured to provide a communication service for the user equipment UE in the serving cell, the JT serving subframe is a normal type subframe, and the JT serving subframe is used to send the JT data of the UE in the serving cell; and

when the UE in the serving cell needs to perform CoMP JT communication, sending, by the coordinated base station, the JT coordinated subframe to the UE in the serving cell to provide a CoMP JT communication service for the UE in the serving cell.

With reference to the first aspect of the embodiments of the present application, in a first implementation manner of the first aspect of the embodiments of the present application, the coordination information includes a control format indicator CFI of the serving cell, and the configuring, by the coordinated base station, a JT coordinated subframe according to the coordination information includes:

configuring, by the coordinated base station, the JT coordinated subframe according to the CFI, so that a symbol quantity of a physical downlink control channel PDCCH of the JT coordinated subframe is the same as that of the JT serving subframe, and in the JT coordinated subframe, a cell-specific reference signal CRS is configured only on the PDCCH.

With reference to the first implementation manner of the first aspect of the embodiments of the present application, in a second implementation manner of the first aspect of the embodiments of the present application, the coordination information further includes a cell identity of the serving cell, and the configuring, by the coordinated base station, a JT coordinated subframe according to the coordination information further includes:

determining, by the coordinated base station, a location of the CRS in the JT serving subframe according to the cell identity of the serving cell, and configuring the JT coordinated subframe, so that in the JT coordinated subframe, the JT data of the UE in the serving cell is configured at a location different from the location of the CRS in the JT serving subframe.

With reference to the first aspect, or the first implementation manner or the second implementation manner of the first aspect of the embodiments of the present application, in a third implementation manner of the first aspect of the embodiments of the present application, before the sending, by the coordinated base station, the JT coordinated subframe to the UE in the serving cell, the method further includes:

sending, by the coordinated base station, radio resource control RRC signaling to UE in a coordinated cell, where the RRC signaling is used to instruct the UE in the coordinated cell not to perform channel measurement on the JT coordinated subframe.

With reference to the third implementation manner of the first aspect of the embodiments of the present application, in a fourth implementation manner of the first aspect of the embodiments of the present application, the RRC signaling is specifically used to notify the UE in the coordinated cell that the JT coordinated subframe is a multimedia broadcast multicast service single frequency network MBSFN subframe.

A second aspect of the embodiments of the present application provides a coordinated multipoint CoMP joint transmission JT communication method, including:

configuring, by a serving base station, a JT serving subframe, where the serving base station is configured to provide a communication service for user equipment UE in a serving cell, the JT serving subframe is a normal type subframe, and the JT serving subframe is used to send JT data of the UE in the serving cell;

sending, by the serving base station, coordination information to a coordinated base station, where the coordination information is used to instruct the coordinated base station to configure a JT coordinated subframe, the JT coordinated subframe is a normal type subframe, and the JT coordinated subframe is used to: when the UE in the serving cell needs to perform CoMP JT communication, send the JT data of the UE in the serving cell together with the JT serving subframe; and

when the UE in the serving cell needs to perform CoMP JT communication, sending, by the serving base station, the JT serving subframe to the UE in the serving cell to provide a CoMP JT communication service for the UE in the serving cell.

With reference to the second aspect of the embodiments of the present application, in a first implementation manner of the second aspect of the embodiments of the present application, the coordination information includes a control format indicator CFI of the serving cell, the CFI indicates a symbol quantity of a physical downlink control channel PDCCH of the JT serving subframe, and the coordination information is used to instruct the coordinated base station to configure the JT coordinated subframe according to the CFI, so that a symbol quantity of a PDCCH of the JT coordinated subframe is the same as that of the JT serving subframe, and in the JT coordinated subframe, a cell-specific reference signal CRS is configured only on the PDCCH.

With reference to the second aspect or the first implementation manner of the second aspect of the embodiments of the present application, the coordination information includes a cell identity of the serving cell, and the coordination information is used to instruct the coordinated base station to determine a location of the CRS in the JT serving subframe according to the cell identity of the serving cell, and configure the JT coordinated subframe, so that in the JT coordinated subframe, the JT data of the UE in the serving cell is configured at a location different from the location of the CRS in the JT serving subframe.

A third aspect of the embodiments of the present application provides a coordinated base station, including:

an information receiving module, configured to receive coordination information from a serving base station;

a second processing module, configured to configure a joint transmission JT coordinated subframe according to the coordination information, where the JT coordinated subframe is a normal type subframe, the JT coordinated subframe is used to: when UE in the serving cell needs to perform coordinated multipoint CoMP JT communication, send JT data of the user equipment UE in the serving cell together with a JT serving subframe configured by the serving base station, the serving base station is configured to provide a communication service for the user equipment UE in the serving cell, the JT serving subframe is a normal type subframe, and the JT serving subframe is used to send the JT data of the UE in the serving cell; and a second communications module, configured to: when the UE in the serving cell needs to perform CoMP JT communication, send the JT coordinated subframe to the UE in the serving cell to provide a CoMP JT communication service for the UE in the serving cell.

With reference to the third aspect of the embodiments of the present application, in a first implementation manner of the third aspect of the embodiments of the present application, the coordination information includes a control format indicator CFI of the serving cell, and the second processing module is specifically configured to:

configure the JT coordinated subframe according to the CFI, so that a symbol quantity of a physical downlink control channel PDCCH of the JT coordinated subframe is the same as that of the JT serving subframe, and in the JT coordinated subframe, a cell-specific reference signal CRS is configured only on the PDCCH.

With reference to the first implementation manner of the third aspect of the embodiments of the present application, in a second implementation manner of the third aspect of the embodiments of the present application, the coordination information further includes a cell identity of the serving base station cell, and the second processing module is further configured to:

determine a location of the CRS in the JT serving subframe according to the cell identity of the serving cell, and configure the JT coordinated subframe, so that in the JT coordinated subframe, the JT data of the UE in the serving cell is configured at a location different from the location of the CRS in the JT serving subframe.

With reference to the third aspect, or the first implementation manner or the second implementation manner of the third aspect of the embodiments of the present application, in a third implementation manner of the third aspect of the embodiments of the present application, the coordinated base station further includes:

a signaling sending module, configured to send radio resource control RRC signaling to UE in a coordinated cell, where the RRC signaling is used to instruct the UE in the coordinated cell not to perform channel measurement on the JT coordinated subframe.

With reference to the third implementation manner of the third aspect of the embodiments of the present application, in a fourth implementation manner of the third aspect of the embodiments of the present application, the RRC signaling is specifically used to notify the UE in the coordinated cell that the JT coordinated subframe is a multimedia broadcast multicast service single frequency network MBSFN subframe.

A fourth aspect of the embodiments of the present application provides a serving base station, where the serving base station is configured to provide a communication service for user equipment UE in a serving cell, and includes:

a first processing module, configured to configure a joint transmission JT serving subframe, where the JT serving subframe is a normal type subframe, and the JT serving subframe is used to send JT data of the UE in the serving cell;

an information sending module, configured to send coordination information to a coordinated base station, where the coordination information is used to instruct the coordinated base station to configure a JT coordinated subframe, the JT coordinated subframe is a normal type subframe, and the JT coordinated subframe is used to: when the UE in the serving cell needs to perform coordinated multipoint CoMP JT communication, send the JT data of the UE in the serving cell together with the JT serving subframe; and

a first communications module, configured to: when the UE in the serving cell needs to perform CoMP JT communication, send the JT serving subframe to the UE in the serving cell to provide a CoMP JT communication service for the UE in the serving cell.

With reference to the fourth aspect of the embodiments of the present application, in a first implementation manner of the fourth aspect of the embodiments of the present application, the coordination information includes a control format indicator CFI of the serving cell, the CFI indicates a symbol quantity of a physical downlink control channel PDCCH of the JT serving subframe, and the coordination information is used to instruct the coordinated base station to configure the JT coordinated subframe according to the CFI, so that a symbol quantity of a PDCCH of the JT coordinated subframe is the same as that of the JT serving subframe, and in the JT coordinated subframe, a cell-specific reference signal CRS is configured only on the PDCCH.

With reference to the fourth aspect or the first implementation manner of the fourth aspect of the embodiments of the present application, in a second implementation manner of the fourth aspect of the embodiments of the present application, the coordination information further includes a cell identity of the serving cell, and the coordination information is used to instruct the coordinated base station to determine a location of the CRS in the JT serving subframe according to the cell identity of the serving cell, and configure the JT coordinated subframe, so that in the JT coordinated subframe, the JT data of the UE in the serving cell is configured at a location different from the location of the CRS in the JT serving subframe.

The embodiments of the present application provide the CoMP JT communication method, where a serving base station configures a normal type subframe as a JT serving subframe; the serving base station sends coordination information to a coordinated base station, so that the coordinated base station configures a JT coordinated subframe; and when UE in the serving cell needs to perform CoMP JT communication, the serving base station sends the JT serving subframe to the UE in the serving cell, and the JT coordinated subframe and the JT serving subframe send JT data of the UE in the serving cell together, to provide a CoMP JT communication service for the UE in the serving cell. By using this method, the serving base station can directly use a normal type subframe to perform CoMP JT communication, and therefore, UE of LTE R9 and an earlier release can also implement CoMP JT communication.

### BRIEF DESCRIPTION OF DRAWINGS

FIG. 1 is a flowchart of an embodiment of a CoMP JT communication method according to an embodiment of the present application;

FIG. 2 is a flowchart of another embodiment of a CoMP JT communication method according to an embodiment of the present application;

FIG. 3 is a structural diagram of an embodiment of a serving base station according to an embodiment of the present application;

FIG. 4 is a structural diagram of another embodiment of a serving base station according to an embodiment of the present application;

FIG. 5 is a structural diagram of an embodiment of a coordinated base station according to an embodiment of the present application; and

FIG. 6 is a structural diagram of another embodiment of a coordinated base station according to an embodiment of the present application.

### DESCRIPTION OF EMBODIMENTS

Embodiments of the present application provide a CoMP JT communication method, used to implement CoMP JT communication in communication of LTE R9 and an earlier release. The embodiments of the present application further provide a related base station, and description is separately provided in the following.

For ease of description and understanding, the following stipulations are particularly made in this application: In CoMP JT communication, a cell in which UE that receives JT data is located is referred to as a serving cell, and a cell that cooperates with the serving cell to provide a CoMP JT service for the UE is referred to as a coordinated cell. A serving base station is configured to provide a communication service for the UE in the serving cell, and a coordinated base station is configured to provide a communication service for UE in the coordinated cell. Preferably, the serving cell and the coordinated cell may be neighboring cells. It may be understood that, there may be one or more coordinated cells, that is, there may be one or more coordinated base stations. It may be understood that, the serving base station and the coordinated base station may be a same base station, or may be different base stations.

It should be understood that, technical solutions of the embodiments of the present application may be applied to various wireless communications systems such as a Long Term Evolution (“LTE” for short) system, a Long Term Evolution Advanced (“LTE-A” for short) system, and a further evolved system, for example, an LTE frequency division duplex (“FDD” for short) system, an LTE time division duplex (“TDD” for short) wireless communications system, and the like.

It should be further understood that, in the embodiments of the present application, user equipment (“UE” for short) may be referred to as a terminal, a mobile station (“MS” for short), a mobile terminal (Mobile Terminal), or the like. The UE may communicate with one or more core networks by using a radio access network (“RAN” for short). For example, the UE may be a mobile phone (or referred to as a “cellular” phone), a computer having a mobile terminal, or the like. For example, the UE may be a portable, pocket-sized, handheld, computer built-in, or vehicle-mounted mobile apparatus, which exchanges voice and/or data with the radio access network.

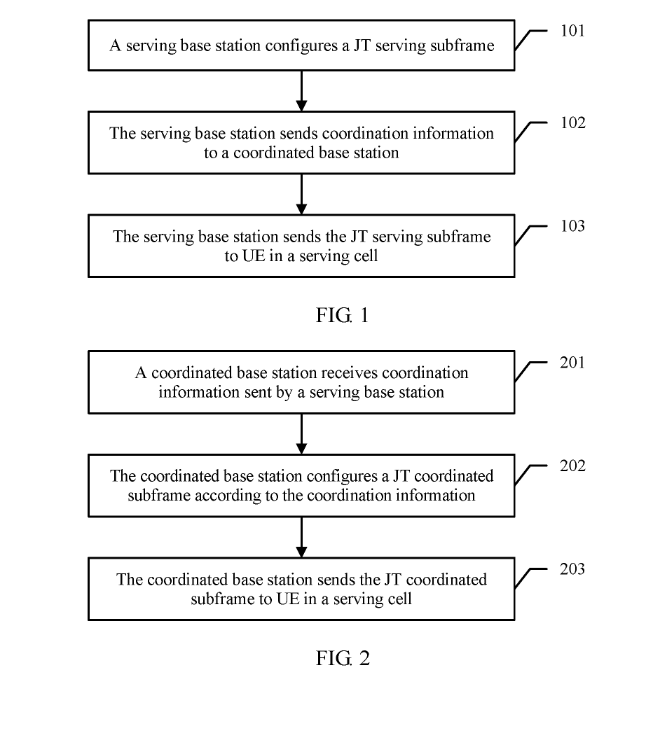

In the embodiments of the present application, both the serving base station and the coordinated base station may be evolved NodeBs (Evolutional Node B, “eNB” for short) in LTE. First, the CoMP JT communication method provided in this application is described from a perspective of the serving base station. For a basic procedure of the CoMP JT communication method, refer to FIG. 1. The basic procedure mainly includes the following steps.

101. The serving base station configures a JT serving subframe.

Because UE of LTE R9 and an earlier release cannot transparently receive JT data sent on an MBSFN subframe, a normal type subframe is used in this embodiment of the present application to schedule the JT data.

In this embodiment of the present application, the normal type subframe has the most fundamental and the bottommost frame structure. The UE of LTE R9 and an earlier release can transparently receive data sent by using the normal type subframe.

The serving base station configures the normal type subframe as a JT serving subframe, and the JT serving subframe is used to send JT data of UE in a serving cell. In this embodiment of the present application, the JT data refers to data used by the UE in the serving cell to perform CoMP JT communication.

102. The serving base station sends coordination information to the coordinated base station.

To implement CoMP JT communication in this embodiment, after configuring the JT serving subframe, the serving base station sends the coordination information to the coordinated base station, so that the coordinated base station configures a JT coordinated subframe. The coordination information is used to instruct the coordinated base station to configure the JT coordinated subframe. The JT coordinated subframe is a normal type subframe, and is used to: when the UE in the serving cell needs to perform CoMP JT communication, send the JT data of the UE in the serving cell together with the JT serving subframe.

103. The serving base station sends the JT serving subframe to UE in a serving cell.

When the UE in the serving cell needs to perform CoMP JT communication, the serving base station sends the JT serving subframe to the UE in the serving cell, to provide a CoMP JT communication service for the UE in the serving cell.

According to a function of the JT coordinated subframe, it may be understood that, in this step, when the UE in the serving cell needs to perform CoMP JT communication, the coordinated base station sends the JT coordinated subframe to the UE in the serving cell, so that the JT coordinated subframe and the JT serving subframe send the JT data of the UE in the serving cell together, to provide the CoMP JT communication service for the UE in the serving cell.

In this embodiment, a serving base station configures a normal type subframe as a JT serving subframe, and the serving base station sends coordination information to a coordinated base station, so that the coordinated base station configures a JT coordinated subframe. When UE in a serving cell needs to perform CoMP JT communication, the serving base station sends the JT serving subframe to the UE in the serving cell, and the JT coordinated subframe and the JT serving subframe send JT data of the UE in the serving cell together, to provide a CoMP JT communication service for the UE in the serving cell. By using this method, the serving base station can directly use a normal type subframe to perform CoMP JT communication, and therefore, UE of LTE R9 and an earlier release can also implement CoMP JT communication.

In this embodiment of the present application, a normal subframe is used to schedule JT data. However, when a coordinated cell also directly uses a normal subframe to schedule JT data, problems of UE reception abnormality and cell-specific reference signal (CRS) conflicting occur. A symbol quantity of a physical downlink control channel (PDCCH) of a subframe that is used to schedule JT data and of a serving cell may be different from a symbol quantity of a physical downlink control channel of a subframe that is used to schedule JT data and of the coordinated cell, and the UE can identify only the symbol quantity of the PDCCH of the serving cell but cannot identify the symbol quantity of the PDCCH of the coordinated cell. Therefore, after receiving JT data from a base station of the coordinated cell, the UE may not correctly decode the JT data sent by the coordinated cell. In addition, in an existing LTE network, because CRS shifts CRS_shift of neighboring cells are configured as different values, a location that is of a subframe of the serving cell and used to transmit JT data may be used to configure the CRS in the coordinated cell, and cannot be used to send JT data. Even if transmit power of the CRS of the coordinated cell is lowered, and the JT data is sent by means of superposition, a severe CRS interference problem still occurs, which leads to unsatisfactory CoMP JT communication effects.

To resolve the foregoing problem, in this embodiment, the serving base station sends the coordination information to the coordinated base station. The coordination information may include a control format indicator (CFI) of the serving base station. The CFI indicates a symbol quantity of a PDCCH of the JT serving subframe, so that the coordinated base station configures the JT coordinated subframe according to the CFI. A symbol quantity of a PDCCH of the JT coordinated subframe is the same as that of the JT serving subframe, and in the JT coordinated subframe, a CRS is configured only on the PDCCH. Because the symbol quantity of the PDCCH of the JT coordinated subframe is the same as that of the JT serving subframe, even if the UE in the serving cell cannot identify the symbol quantity of the PDCCH of the JT coordinated subframe, the UE in the serving cell can still correctly decode JT data in the JT coordinated subframe. In addition, in the JT coordinated subframe, the CRS is configured only on the PDCCH. Therefore, a location that is of a subframe of the serving cell and used to transmit JT data is definitely not used to configure the CRS in the coordinated cell. Therefore, the CRS interference problem does not exist, and the CoMP JT communication effects are improved.

More preferably, the coordination information may further include a cell identity (cell ID) of the serving cell. The coordinated base station determines a location of the CRS in the JT serving subframe according to the cell identity of the serving cell, and evades the location of the CRS in the JT serving subframe when configuring the JT coordinated subframe, so that in the JT coordinated subframe, the JT data of the UE in the serving cell is configured at a location different from the location of the CRS in the JT serving subframe. By using this method, a case in which the JT data cannot be received by the UE in the serving cell because the JT data is configured at a location same as the location of the CRS in the JT serving subframe is avoided in the JT coordinated subframe, so that the UE in the serving cell can receive more complete JT data. To implement CoMP JT communication, the coordination information may further include other parameters, so that the coordinated base station further completes JT coordinated subframe configuration and CoMP JT communication according to these parameters. Specifically, the coordination information may include a scramble ID (SCID) and a demodulation reference signal (DMRS) ID that are of the UE. The coordinated base station can obtain an initial value of a DMRS sequence by using the SCID and the serving cell identity, or by using the DMRS ID. The coordination information may further include a resource location scheduled by a JT user, the coordination information may further include a modulation and coding scheme (MCS) of the UE in the serving cell, and the coordination information may further include a downlink transmit weighted value of the coordinated cell, which is used to instruct the coordinated base station to cooperate with the serving base station to perform CoMP JT communication in different manners. The coordination information may further include another parameter, which is not limited in this embodiment.

The foregoing embodiment describes the CoMP JT communication method in this application from the perspective of the serving base station. The following describes the CoMP JT communication method provided in this application from the perspective of the coordinated base station. Referring to FIG. 2, the CoMP JT communication method includes the following steps.

201. The coordinated base station receives coordination information from the serving base station.

The coordinated base station receives the coordination information from the serving base station. A function of the coordination information is almost the same as the content described in the first embodiment, and includes: when UE in a serving cell needs to perform CoMP JT communication, sending JT data of the UE in the serving cell together with a JT serving subframe configured by the serving base station.

202. The coordinated base station configures a JT coordinated subframe according to the coordination information.

After receiving the coordination information, the coordinated base station configures the JT coordinated subframe according to the coordination information. The JT coordinated subframe is a normal type subframe, and is used to: when the UE in the serving cell needs to perform CoMP JT communication, send the JT data of the UE in the serving cell together with the JT serving subframe configured by the serving base station.

203. The coordinated base station sends the JT coordinated subframe to UE in a serving cell.

When the UE in the serving cell needs to perform CoMP JT communication, the coordinated base station sends the JT coordinated subframe to the UE in the serving cell to provide a CoMP JT communication service for the UE in the serving cell.

According to a function of the JT coordinated subframe, it may be understood that, in this step, when the UE in the serving cell needs to perform CoMP JT communication, the serving base station also sends the JT serving subframe to the UE in the serving cell, so that the JT serving subframe and the JT coordinated subframe send the JT data of the UE in the serving cell together, to provide the CoMP JT communication service for the UE in the serving cell.

In this embodiment, a coordinated base station receives coordination information from a serving base station, and configures a JT coordinated subframe according to the coordination information. When UE in a serving cell needs to perform CoMP JT communication, the serving base station sends a JT serving subframe to the UE in the serving cell, and the coordinated base station sends the JT coordinated subframe to the UE in the serving cell. The JT serving subframe and the JT coordinated subframe send JT data of the UE in the serving cell together, to provide a CoMP JT communication service for the UE in the serving cell. By using this method, the coordinated base station can directly use a normal type subframe to perform CoMP JT communication, and therefore, UE of LTE R9 and an earlier release can also implement CoMP JT communication.

As mentioned in the first embodiment, when the coordinated cell directly uses the normal subframe to schedule the JT data, problems of UE reception abnormality and CRS conflicting occur. To resolve the foregoing problems, in this embodiment, the coordination information may include a CFI. The CFI indicates a symbol quantity of a PDCCH of the JT serving subframe. The coordinated base station configures the JT coordinated subframe according to the CFI, so that a symbol quantity of a PDCCH of the JT coordinated subframe is the same as that of the JT serving subframe, and in the JT coordinated subframe, a CRS is configured only on the PDCCH. Because the symbol quantity of the PDCCH of the JT coordinated subframe is the same as that of the JT serving subframe, even if the UE in the serving cell cannot identify the symbol quantity of the PDCCH of the JT coordinated subframe, the UE in the serving cell can still correctly decode JT data in the JT coordinated subframe. In addition, in the JT coordinated subframe, the CRS is configured only on the PDCCH. Therefore, a location that is of a subframe of the serving cell and used to transmit JT data is definitely not used to configure the CRS in the coordinated cell. Therefore, a CRS interference problem does not exist, and CoMP JT communication effects are improved.

More preferably, the coordination information may further include a cell identity of the serving cell. The coordinated base station determines a location of the CRS in the JT serving subframe according to the cell identity of the serving cell, and evades these locations of the CRS in the JT serving subframe when configuring the JT coordinated subframe, so that in the JT coordinated subframe, the JT data of the UE in the serving cell is configured at a location different from the location of the CRS in the JT serving subframe. By using this method, a case in which the JT data cannot be received by the UE in the serving cell because the JT data is configured at a location same as the location of the CRS in the JT serving subframe is avoided in the JT coordinated subframe, so that the UE in the serving cell can receive more complete JT data.

Because the JT coordinated subframe is used to provide the CoMP JT communication service for the UE in the serving cell, the JT coordinated subframe is redundant data for UE in the coordinated cell, and may affect subsequent measurement and filtering for the UE in the coordinated cell. Therefore, preferably, before sending the JT coordinated subframe to the UE in the serving cell, the coordinated base station may send radio resource control (RRC) signaling to the UE in the coordinated cell, so that the UE in the coordinated cell does not perform channel measurement on the JT coordinated subframe. Therefore, the UE in the coordinated cell does not perform transparent reception in the JT coordinated subframe. Preferably, the RRC signaling may be used to notify the UE in the coordinated cell that the JT coordinated subframe is an MBSFN subframe.

To implement CoMP JT communication, the coordination information may further include other parameters, so that the coordinated base station further completes JT coordinated subframe configuration and CoMP JT communication according to these parameters. Specifically, the coordination information may include a scramble ID (SCID) and a demodulation reference signal (DMRS) ID that are of the UE. The coordinated base station can obtain an initial value of a DMRS sequence by using the SCID and the serving cell identity, or by using the DMRS ID. The coordination information may further include a resource location scheduled by a JT user, the coordination information may further include a modulation and coding scheme (MCS) of the UE in the serving cell, and the coordination information may further include a downlink transmit weighted value of the coordinated cell, which is used to instruct the coordinated base station to cooperate with the serving base station to perform CoMP JT communication in different manners. The coordination information may further include another parameter, which is not limited in this embodiment.

The serving base station and the coordinated base station may exchange information with each other by using the following base station information exchange methods:

(1) If the serving base station and the coordinated base station are a same base station, and the serving cell and the coordinated cell are managed by a same baseband processing unit, the base station performs information exchange by using an intra-baseband processing unit communications manner.

(2) If the serving base station and the coordinated base station are a same base station, and the serving cell and the coordinated cell are managed by different baseband processing units, the base station performs information exchange by using an inter-baseband processing unit communications manner.

(3) If the serving base station and the coordinated base station are different base stations, the serving base station and the coordinated base station perform data communication by using an X2 interface, to implement information exchange.

That the serving base station sends the coordination information to the coordinated base station may be implemented by using the base station information exchange methods in (1) to (3).

Before CoMP JT communication is performed, the serving base station needs to notify the coordinated base station when to perform CoMP JT communication. The serving base station may also notify, by using the base station information exchange methods in (1) to (3), the coordinated base station when to perform CoMP JT communication.

Separately from the perspective of the serving base station and the perspective of the coordinated base station, the foregoing embodiments describe the CoMP JT communication method provided in the embodiments of the present application. However, in actual application, a cell in which UE that receives a CoMP JT communication service is located is uncertain. Therefore, whether a cell is a serving cell or a coordinated cell, and whether a base station is a serving base station or a coordinated base station are not invariable. A cell in which UE receiving the CoMP JT communication service is located is a serving cell, and a base station that provides a service for the UE in the serving cell is a serving base station.

Specifically, when there are multiple base stations performing CoMP JT communication, the multiple base stations may query in turn whether their cells have UE that receives the CoMP JT communication service. If its cell has UE that receives the CoMP JT communication service, a base station is determined as a serving base station, and another base station as a coordinated base station.

In particular, when there are multiple base stations performing CoMP JT communication, whether there is UE that receives the CoMP JT communication service may not be determined, and each base station serves as a serving base station in turn.

Separately from the perspective of the serving base station and the perspective of the coordinated base station, the foregoing embodiments describe the CoMP JT communication method provided in the embodiments of the present application, and describe how to determine the serving base station and the coordinated base station. The following uses a specific application scenario for description.

A base station A, a base station B, and a base station C query in turn whether their cells have UE that receives a CoMP JT communication service. At the current moment, the base station A queries and discovers that a cell in which the base station A is located has UE that receives the CoMP JT communication service, and the UE does not support an LTE R10 release but supports an LTE R9 release. Therefore, the base station A is determined as a serving base station, and the base station B and the base station C as coordinated base stations.

The base station A configures JT data on a normal subframe, and the subframe is referred to as a JT serving subframe. Then, the base station A sends coordination information to the base station B and the base station C. The coordination information includes CFI information of the base station A and a cell identity of the cell in which the base station A is located. The CFI information indicates that a symbol quantity of a PDCCH of the JT serving subframe configured by the base station A is 2.

The base station B and the base station C separately receive the coordination information from the base station A, and separately configure a coordinated subframe B and a coordinated subframe C according to the CFI and the cell identity in the coordination information. In the coordinated subframe B and the coordinated subframe C, a symbol quantity of a PDCCH is also 2. No CRS is configured at other locations, except a PDCCH location, in the subframe B and the subframe C. The base station B and the base station C obtain through calculation, according to the cell identity, a location of a CRS in the subframe of the cell in which A is located, and in the coordinated subframe B and the coordinated subframe C, avoid using these locations to carry the JT data.

The base station A uses the JT serving subframe, the base station B uses the coordinated subframe B, and the base station C uses the coordinated subframe C to perform CoMP JT communication.

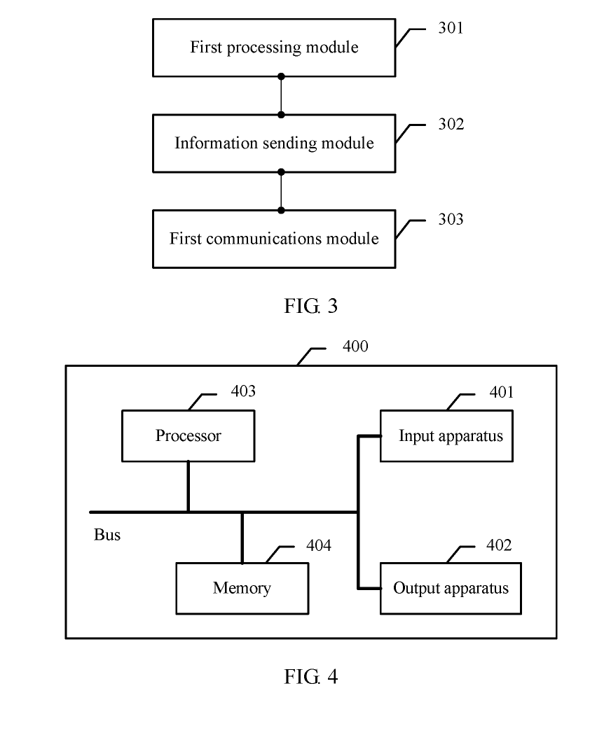

An embodiment of the present application further provides a base station that can implement the foregoing method. This application first provides description from a perspective of a serving base station. Referring to FIG. 3, a main structure of the serving base station provided in this application includes:

a first processing module 301, configured to configure a JT serving subframe, where the JT serving subframe is a normal type subframe, and the JT serving subframe is used to send JT data of UE in a serving cell;

an information sending module 302, configured to send coordination information to a coordinated base station, so that the coordinated base station configures a JT coordinated subframe according to the coordination information, where the coordinated base station is configured to provide a communication service for UE in a coordinated cell, and provide a CoMP JT communication service for the UE in the serving cell together with the serving base station, the coordination information is used to instruct the coordinated base station to configure the JT coordinated subframe, the JT coordinated subframe is a normal type subframe, and the JT coordinated subframe is used to: when the UE in the serving cell needs to perform CoMP JT communication, send the JT data of the UE in the serving cell together with the JT serving subframe; and

a first communications module 303, configured to: when the UE in the serving cell needs to perform CoMP JT communication, send the JT serving subframe to the UE in the serving cell to provide the CoMP JT communication service for the UE in the serving cell.

In this embodiment, the first processing module 301 configures a normal type subframe as a JT serving subframe, and the information sending module 302 sends coordination information to a coordinated base station, so that the coordinated base station configures a JT coordinated subframe. When UE in a serving cell needs to perform CoMP JT communication, the first communications module 303 sends the JT serving subframe to the UE in the serving cell, and the JT coordinated subframe and the JT serving subframe send JT data of the UE in the serving cell together, to provide a CoMP JT communication service for the UE in the serving cell. In this way, the serving base station can directly use a normal type subframe to perform CoMP JT communication, and therefore, UE of LTE R9 and an earlier release can also implement CoMP JT communication.

Specifically, the information sending module 302 may be configured to send the coordination information to the coordinated base station. The coordination information includes a CFI of the serving cell, so that the coordinated base station configures the JT coordinated subframe according to the CFI. A symbol quantity of a PDCCH of the JT coordinated subframe is the same as that of the JT serving subframe, and in the JT coordinated subframe, a CRS is configured only on the PDCCH.

Preferably, the information sending module 302 may be further configured to send the coordination information to the coordinated base station. The coordination information includes a cell identity of the serving cell, so that the coordinated base station determines a location of the CRS in the JT serving subframe according to the cell identity of the serving cell, and configures the JT coordinated subframe, so that in the JT coordinated subframe, the JT data of the UE in the serving cell is configured at a location different from the location of the CRS in the JT serving subframe.

The foregoing describes the serving base station in this embodiment of the present application from a perspective of a unit functional entity, and the following describes the serving base station in this embodiment of the present application from a perspective of hardware processing. Referring to FIG. 4, another embodiment of a serving base station 400 in this embodiment of the present application includes:

an input apparatus 401, an output apparatus 402, a processor 403, and a memory 404 (the serving base station 400 may have one or more processors 403, and one processor 403 is used as an example in FIG. 4), where in some embodiments of the present application, the input apparatus 401, the output apparatus 402, the processor 403, and the memory 404 may be connected by using a bus or in another manner, and a bus connection is used as an example in FIG. 4.

By invoking an operation instruction stored in the memory 404, the processor 403 is configured to perform the following steps: configuring a JT serving subframe; sending coordination information to a coordinated base station; and sending the JT serving subframe to UE in a serving cell.

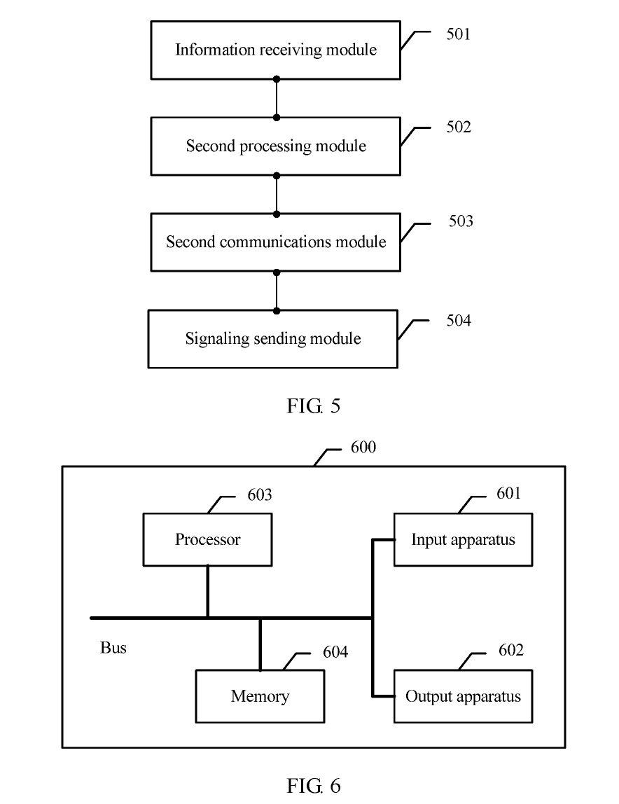

The embodiments in FIG. 3 and FIG. 4 are described from the perspective of the serving base station, and the following provides description from a perspective of a coordinated base station. Referring to FIG. 5, a main structure of the coordinated base station provided in this application includes:

an information receiving module 501, configured to receive coordination information from a serving base station;

a second processing module 502, configured to configure a JT coordinated subframe according to the coordination information, where the JT coordinated subframe is a normal type subframe, and is used to: when UE in a serving cell needs to perform CoMP JT communication, send JT data of the UE in the serving cell together with a JT serving subframe configured by the serving base station; and

a second communications module 503, configured to: when the UE in the serving cell needs to perform CoMP JT communication, send the JT coordinated subframe to the UE in the serving cell to provide a CoMP JT communication service for the UE in the serving cell.

In this embodiment, the information receiving module 501 receives coordination information from a serving base station, and the second processing module 502 configures a JT coordinated subframe according to the coordination information. When UE in a serving cell needs to perform CoMP JT communication, the serving base station sends a JT serving subframe to the UE in the serving cell, and the second communications module 503 of the coordinated base station sends the JT coordinated subframe to the UE in the serving cell. The JT serving subframe and the JT coordinated subframe send JT data of the UE in the serving cell together, to provide a CoMP JT communication service for the UE in the serving cell. The coordinated base station provided in this embodiment can directly use a normal type subframe to perform CoMP JT communication, and therefore, UE of LTE R9 and an earlier release can also implement CoMP JT communication.

Specifically, the coordination information in this embodiment may include a CFI of the serving cell. The second processing module 502 may configure the JT coordinated subframe according to the CFI, so that a symbol quantity of a PDCCH of the JT coordinated subframe is the same as that of the JT serving subframe, and in the JT coordinated subframe, a CRS is configured only on the PDCCH.

More specifically, the coordination information in this embodiment may include a cell identity of the serving base station cell, the second processing module 502 may be further configured to: determine a location of the CRS in the JT serving subframe according to the cell identity of the serving cell, and configure the JT coordinated subframe, so that in the JT coordinated subframe, the JT data of the UE in the serving cell is configured at a location different from the location of the CRS in the JT serving subframe.

Preferably, the coordinated base station may further include a signaling sending module 504, configured to send RRC signaling to UE in a coordinated cell, so that the UE in the coordinated cell does not perform channel measurement on the JT coordinated subframe. Specifically, the RRC signaling may be used to notify the UE in the coordinated cell that the JT coordinated subframe is an MBSFN subframe.

The foregoing describes the coordinated base station in this embodiment of the present application from a perspective of a unit functional entity, and the following describes the coordinated base station in this embodiment of the present application from a perspective of hardware processing. Referring to FIG. 6, another embodiment of a coordinated base station 600 in this embodiment of the present application includes:

an input apparatus 601, an output apparatus 602, a processor 603, and a memory 604 (the coordinated base station 600 may have one or more processors 603, and one processor 603 is used as an example in FIG. 6), where in some embodiments of the present application, the input apparatus 601, the output apparatus 602, the processor 603, and the memory 604 may be connected by using a bus or in another manner, and a bus connection is used as an example in FIG. 6.

By invoking an operation instruction stored in the memory 604, the processor 603 is configured to perform the following steps: receiving coordination information from a serving base station; configuring a JT coordinated subframe according to the coordination information; sending the JT coordinated subframe to UE in a serving cell; and sending RRC signaling to UE served by the coordinated base station, so that UE in a coordinated cell does not perform channel measurement on the JT coordinated subframe.

The foregoing embodiments and instances separately describe, from the perspective of the serving base station and the coordinated base station, the base stations provided in the embodiments of the present application. However, in actual application, a cell in which UE that receives a CoMP JT communication service is located is uncertain. Therefore, whether a cell is a serving cell or a coordinated cell, and whether a base station is a serving base station or a coordinated base station are not invariable. A cell in which UE that receives the CoMP JT communication service is located is a serving cell, and a base station of the cell is a serving base station. Therefore, a base station of a cell may include a first processing module, an information sending module, and a first communications module of a serving base station, but also may include an information receiving module, a second processing module, a second communications module, and a signaling sending module of a coordinated base station.

The following uses a specific application scenario as an example to describe the base stations provided in the embodiments of the present application.

A base station A, a base station B, and a base station C query in turn whether their cells have UE that receives a CoMP JT communication service. At the current moment, the base station A queries and discovers that a cell in which the base station A is located has UE that receives the CoMP JT communication service, and the UE does not support an LTE R10 release but supports an LTE R9 release. Therefore, the base station A is determined as a serving base station, and the base station B and the base station C as coordinated base stations.

A first processing module 301 of the base station A configures JT data on a normal subframe, where the subframe is referred to as a JT serving subframe. Then, an information sending module 302 of the base station A sends coordination information to the base station B and the base station C, where the coordination information includes CFI information of the base station A and a cell identity of the cell in which the base station A is located. The CFI information indicates that a symbol quantity of a PDCCH of the JT serving subframe configured by the base station A is 2.

The base station B and the base station C separately receive the coordination information from the information sending module 302, and respectively configure a coordinated subframe B and a coordinated subframe C according to the CFI and the cell identity in the coordination information. In the coordinated subframe B and the coordinated subframe C, a symbol quantity of a PDCCH is also 2. No CRS is configured at other locations, except a PDCCH location, in the subframe B and the subframe C. The base station B and the base station C obtain through calculation, according to the cell identity, a location of a CRS in the subframe of the cell in which A is located, and in the coordinated subframe B and the coordinated subframe C, avoid using these locations to carry the JT data.

A first communications module 303 of the base station A uses the JT serving subframe, the base station B uses the coordinated subframe B, and the base station C uses the coordinated subframe C, to perform CoMP JT communication.

It may be clearly understood by persons skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in this application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present application essentially, or the part contributing to the prior art, or all or some of the technical solutions may be implemented in the form of a software product. The software product is stored in a storage medium and includes several instructions for instructing a computer device (which may be a personal computer, a server, or a network device) to perform all or some of the steps of the methods described in the embodiments of the present application. The foregoing storage medium includes: any medium that can store program code, such as a USB flash drive, a removable hard disk, a read-only memory (ROM), a random access memory (RAM), a magnetic disk, or an optical disc.

The foregoing embodiments are merely intended for describing the technical solutions of the present application, but not for limiting the present application. Although the present application is described in detail with reference to the foregoing embodiments, persons of normal skill in the art should understand that they may still make modifications to the technical solutions described in the foregoing embodiments or make equivalent replacements to some technical features thereof, without departing from the spirit and scope of the technical solutions of the embodiments of the present application.

What is claimed is:

1. A coordinated multipoint (CoMP) joint transmission (JT) communication method, comprising:
receiving, by a coordinated base station, coordination information from a serving base station, wherein the serving base station is configured to provide a communication service to a user equipment (UE) in a serving cell of the serving base station;
configuring, by the coordinated base station, a JT coordinated subframe according to the coordination information, wherein the JT coordinated subframe is a normal type subframe, the JT coordinated subframe is used to send JT data of the UE in the serving cell together with a JT serving subframe configured by the serving base station, the JT serving subframe is a normal type subframe; and
when the UE in the serving cell needs to perform CoMP JT communication, sending, by the coordinated base station, the JT coordinated subframe to the UE in the serving cell to provide a CoMP JT communication service for the UE in the serving cell.

2. The CoMP JT communication method according to claim 1, wherein the coordination information comprises a control format indicator (CFI) of the serving cell, and the configuring, by the coordinated base station, a JT coordinated subframe according to the coordination information comprises:
configuring, by the coordinated base station, the JT coordinated subframe according to the CFI, so that a symbol quantity of a physical downlink control channel (PDCCH) of the JT coordinated subframe is the same as that of the JT serving subframe, and in the JT coordinated subframe, a cell-specific reference signal (CRS) is configured only on the PDCCH.

3. The CoMP JT communication method according to claim 2, wherein the coordination information further comprises a cell identity of the serving cell, and the configuring, by the coordinated base station, a JT coordinated subframe according to the coordination information further comprises:
determining, by the coordinated base station, a location of the CRS in the JT serving subframe according to the cell identity of the serving cell, and configuring the JT coordinated subframe, so that in the JT coordinated subframe, the JT data of the UE in the serving cell is configured at a location different from the location of the CRS in the JT serving subframe.

4. The CoMP JT communication method according to claim 1, wherein before the sending, by the coordinated base station, the JT coordinated subframe to the UE in the serving cell, the method further comprises:
sending, by the coordinated base station, radio resource control (RRC) signaling to UE in a coordinated cell, wherein the RRC signaling is used to instruct the UE in the coordinated cell not to perform channel measurement on the JT coordinated subframe.

5. The CoMP JT communication method according to claim 4, wherein the RRC signaling is specifically used to notify the UE in the coordinated cell that the JT coordinated subframe is a multimedia broadcast multicast service single frequency network (MBSFN) subframe.

6. A coordinated multipoint (CoMP) joint transmission (JT) communication method, comprising:
configuring, by a serving base station, a JT serving subframe, wherein the serving base station is configured to provide a communication service for user equipment UE in a serving cell, the JT serving subframe is a normal type subframe, and the JT serving subframe is used to send JT data of the UE in the serving cell;
sending, by the serving base station, coordination information to a coordinated base station, wherein the coordination information is used to instruct the coordinated base station to configure a JT coordinated subframe, the JT coordinated subframe is a normal type subframe, and the JT coordinated subframe is used to send the JT data of the UE in the serving cell together with the JT serving subframe; and
when the UE in the serving cell needs to perform CoMP JT communication, sending, by the serving base station, the JT serving subframe to the UE in the serving cell to provide a CoMP JT communication service for the UE in the serving cell.

7. The CoMP JT communication method according to claim 6, wherein the coordination information comprises a control format indicator CFI of the serving cell, the CFI indicates a symbol quantity of a physical downlink control channel PDCCH of the JT serving subframe, and the coordination information is used to instruct the coordinated base station to configure the JT coordinated subframe according to the CFI, so that a symbol quantity of a PDCCH of the JT coordinated subframe is the same as that of the JT serving subframe, and in the JT coordinated subframe, a cell-specific reference signal CRS is configured only on the PDCCH.

8. The CoMP JT communication method according to claim 7, wherein the coordination information comprises a cell identity of the serving cell, and the coordination information is used to instruct the coordinated base station to determine a location of the CRS in the JT serving subframe according to the cell identity of the serving cell, and configure the JT coordinated subframe, so that in the JT coordinated subframe, the JT data of the UE in the serving cell is configured at a location different from the location of the CRS in the JT serving subframe.

9. A coordinated base station, comprising:
a receiver, configured to receive coordination information from a serving base station;
a processor, configured to:
configure a joint transmission (JT) coordinated subframe according to the coordination information, wherein the JT coordinated subframe is a normal type subframe, the JT coordinated subframe is used to send JT data of a user equipment (UE) in a serving cell together with a JT serving subframe configured by the serving base station, the serving base station is configured to provide a communication service for the UE in the serving cell, the JT serving subframe is a normal type subframe; and
when the UE in the serving cell needs to perform coordinated multipoint (CoMP) JT communication, send the JT coordinated subframe to the UE in the serving cell to provide a CoMP JT communication service for the UE in the serving cell.

10. The coordinated base station according to claim 9, wherein the coordination information comprises a control format indicator (CFI) of the serving cell, and the processor is specifically configured to:
configure the JT coordinated subframe according to the CFI, so that a symbol quantity of a physical downlink control channel (PDCCH) of the JT coordinated subframe is the same as that of the JT serving subframe, and in the JT coordinated subframe, a cell-specific reference signal (CRS) is configured only on the PDCCH.

11. The coordinated base station according to claim 10, wherein the coordination information further comprises a cell identity of the serving cell, and the processor is further configured to:
determine a location of the CRS in the JT serving subframe according to the cell identity of the serving cell, and configure the JT coordinated subframe, so that in the JT coordinated subframe, the JT data of the UE in the serving cell is configured at a location different from the location of the CRS in the JT serving subframe.

12. The coordinated base station according to claim 9, wherein the coordinated base station further comprises:
transmitter, configured to send radio resource control (RRC) signaling to UE in a coordinated cell, wherein the RRC signaling is used to instruct the UE in the coordinated cell not to perform channel measurement on the JT coordinated subframe.

13. The coordinated base station according to claim 12, wherein the RRC signaling is specifically used to notify the UE in the coordinated cell that the JT coordinated subframe is a multimedia broadcast multicast service single frequency network (MBSFN) subframe.
